(19) United States
(12) Patent Application Publication
(10) Pub. No.: US 2026/0172090 A1
(43) Pub. Date: Jun. 18, 2026

(54) RANDOM ACCESS CHANNEL DESIGN FOR WIRELESS COMMUNICATIONS

(71) Applicant: Lenovo (United States) Inc., Morrisville, NC (US)

(72) Inventors: Hossein Bagheri, Dearborn Heights, MI (US); Vijay Nangia, Woodridge, IL (US); Karthikeyan Ganesan, Kronberg im Taunus (DE)

(21) Appl. No.: 18/981,074

(22) Filed: Dec. 13, 2024

(51) Int. Cl. H04B 7/06; H04L 5/00

(52) U.S. Cl. CPC H04B 7/0626; H04L 5/0005

(57) ABSTRACT

Various aspects of the present disclosure relate to receiving a first random access channel (RACH) configuration and a second RACH configuration, where the first RACH configuration is associated with a first set of RACH occasions (ROs) based on the and the second RACH configuration is associated with a second set of ROs based on; determining a set of valid ROs based on the first set of ROs and the second set of ROs, where the set of valid ROs excludes ROs of the second set of ROs, and where at least one RO of the set of valid ROs is associated with the first set of ROs; and transmitting a RACH transmission in a RO of the set of valid ROs.

### TECHNICAL FIELD

The present disclosure relates to wireless communications, and more specifically to techniques for random access channel (RACH) design for wireless communications, including low power wide area (LPWA) communications.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to receive a first RACH configuration and a second RACH configuration, where the first RACH configuration is associated with a first set of RACH occasions (ROs) and the second RACH configuration is associated with a second set of ROs; determine a set of valid ROs based on the first set of ROs and the second set of ROs, where the set of valid ROs excludes ROs of the second set of ROs, and where at least one RO of the set of valid ROs is associated with the first set of ROs; and transmit a RACH transmission in a RO of the set of valid ROs.

A processor for wireless communication is described. The processor may be configured to, capable of, or operable to receive a first RACH configuration and a second RACH configuration, where the first RACH configuration is associated with a first set of ROs and the second RACH configuration is associated with a second set of ROs; determine a set of valid ROs based on the first set of ROs and the second set of ROs, where the set of valid ROs excludes ROs of the second set of ROs, and where at least one RO of the set of valid ROs is associated with the first set of ROs; and transmit a RACH transmission in a RO of the set of valid ROs.

A method performed or performable by a UE for wireless communication is described. The method may include receiving a first RACH configuration and a second RACH configuration, where the first RACH configuration is associated with a first set of ROs and the second RACH configuration is associated with a second set of ROs; determining a set of valid ROs based on the first set of ROs and the second set of ROs, where the set of valid ROs excludes ROs of the second set of ROs, and where at least one RO of the set of valid ROs is associated with the first set of ROs; and transmitting a RACH transmission in a RO of the set of valid ROs.

A base station for wireless communication is described. The base station may be configured to, capable of, or operable to transmit a first RACH configuration and a second RACH configuration, where the first RACH configuration is associated with a first set of ROs and the second RACH configuration is associated with a second set of ROs; determine, for a set of UEs, a set of valid ROs based on the first set of ROs and the second set of ROs, where the set of valid ROs excludes ROs of the second set of ROs, and where at least one RO of the set of valid ROs is associated with the first set of ROs; and receive, from a UE, a RACH transmission in a RO of the set of valid ROs.

A processor for wireless communication is described. The processor may be configured to, capable of, or operable to transmit a first RACH configuration and a second RACH configuration, where the first RACH configuration is associated with a first set of ROs and the second RACH configuration is associated with a second set of ROs; determine, for a set of UEs, a set of valid ROs based on the first set of ROs and the second set of ROs, where the set of valid ROs excludes ROs of the second set of ROs, and where at least one RO of the set of valid ROs is associated with the first set of ROs; and receive, from a UE, a RACH transmission in a RO of the set of valid ROs.

A method performed or performable by a base station for wireless communication is described. The method may include transmitting a first RACH configuration and a second RACH configuration, where the first RACH configuration is associated with a first set of ROs and the second RACH configuration is associated with a second set of ROs; determining, for a set of UEs, a set of valid ROs based on the first set of ROs and the second set of ROs, where the set of valid ROs excludes ROs of the second set of ROs, and where at least one RO of the set of valid ROs is associated with the first set of ROs; and receiving, from a UE, a RACH transmission in a RO of the set of valid ROs.

### BRIEF DESCRIPTION OF THE DRAWINGS

FIG. 1 illustrates an example of a wireless communications system in accordance with aspects of the present disclosure.

FIG. 2A illustrates an example of an initial access procedure in accordance with aspects of the present disclosure.

FIG. 2B illustrates an example of a synchronization signal block (SSB) burst set comprising multiple SSB transmissions, in accordance with aspects of the present disclosure.

FIG. 3 illustrates an example of a transmission diagram, in accordance with aspects of the present disclosure.

FIG. 4 illustrates an example of mapping SSB beams and RACH preambles to ROs, in accordance with aspects of the present disclosure.

FIG. 5 illustrates another example of mapping SSB beams and RACH preambles to ROs, in accordance with aspects of the present disclosure.

FIG. 6 illustrates an example of a transmission diagram for different system information block (SIB) type 1 (SIB1) transmissions, in accordance with aspects of the present disclosure.

FIG. 7 illustrates an example of a diagram for determining different RACH configurations from a SIB1 transmission, in accordance with aspects of the present disclosure.

FIG. 8 illustrates an example of a first allocation scheme for ROs of LPWA UEs and non-LPWA UEs, in accordance with aspects of the present disclosure.

FIG. 9 illustrates an example of a second allocation scheme for ROs of LPWA UEs and non-LPWA UEs, in accordance with aspects of the present disclosure.

FIG. 10 illustrates an example of a third allocation scheme for ROs of LPWA UEs and non-LPWA UEs, in accordance with aspects of the present disclosure.

FIG. 11 illustrates an example of a protocol stack, in accordance with aspects of the present disclosure.

FIG. 12 illustrates an example of a UE, in accordance with aspects of the present disclosure.

FIG. 13 illustrates an example of a processor, in accordance with aspects of the present disclosure.

FIG. 14 illustrates an example of a NE, in accordance with aspects of the present disclosure.

FIG. 15 illustrates a flowchart of a method performed by a UE, in accordance with aspects of the present disclosure.

FIG. 16 illustrates a flowchart of a method performed by a NE, in accordance with aspects of the present disclosure.

### DETAILED DESCRIPTION

Some wireless communication systems may support one or more energy saving techniques. In some examples, a UE and/or a NE (e.g., a base station) in the wireless communications system can operate in one or more different modes that result in different power consumption by the UE and/or the NE including, but not limited to, an inactive or idle mode and an active mode. In the inactive mode or the idle mode, the UE and/or the NE can refrain from actively communicating (e.g., transmitting and receiving) signaling, leading to power savings as the components that perform the communicating can be powered down and/or enter a reduced power consumption state. In the active mode, the UE and/or the NE can communicate signaling, leading to a relatively high power consumption when compared with the power saving mode due to the components that perform the communicating being in an active state to transmit, receive, decode, and/or otherwise process the signaling.

A UE may operate as a low power wide area (LPWA) device. The power consumption of the related digital baseband processing for LPWA UEs scales with bandwidth, and hence, such devices may operate with limited bandwidth to maintain low power consumption. The limited bandwidth operation is suitable to support internet-of-things (IoT) communications, among other lower-power communication types.

Because the same cell may support both LPWA UEs (i.e., IoT devices capable of communication only within a limited BW with limited number of transmit/receive antennas, and/or requiring extended coverage) and non-LPWA UEs, cells may support a modified random access procedure for establishing a connection with the network. Accordingly, aspects of the present disclosure include techniques for determining RACH configuration and RACH resources/occasions (in time, frequency, preamble, etc. domains) by both LPWA UEs and non-LPWA UEs in a cell containing both UE types.

Certain aspects of the present disclosure include techniques for determining ROs of LPWA UEs and non-LPWA UEs based on the same broadcast signal or the same RACH configuration. Further aspects of the present disclosure include techniques for minimizing overlap between RACH resources of LPWA and non-LPWA UEs (using same or different system information blocks (SIB)).

Additionally, while presented as distinct solutions, one or more of the solutions described herein may be implemented in combination with each other. Aspects of the present disclosure are described in the context of a wireless communications system.

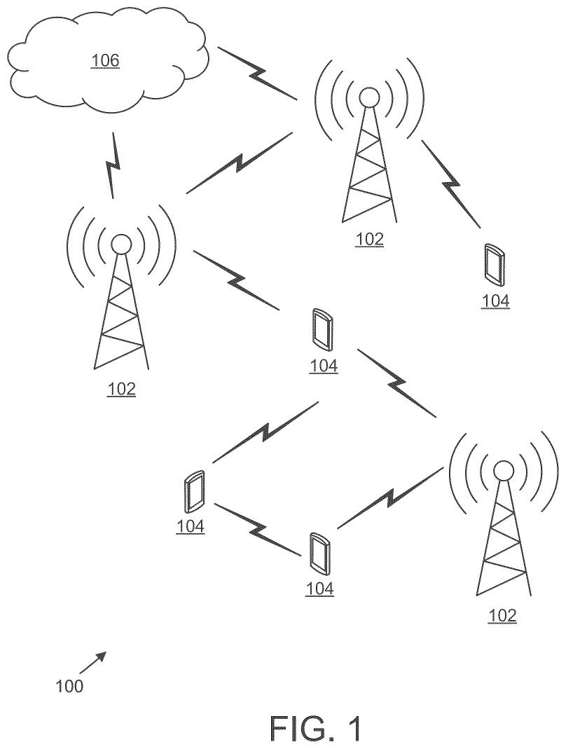

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure.

In various implementations, the NE 102 may transmit a first RACH configuration and a second RACH configuration, the first RACH configuration associated with a first set of ROs and the second RACH configuration associated with a second set of ROs. A RO is characterized by a set of time resources (e.g., one or more OFDM symbols within specific subframes), a set of frequency resources (e.g., one or more resource blocks (RBs) within an uplink (UL) bandwidth part (BWP)), and a set of candidate PRACH preambles. Note that a RACH configuration may indicate a preamble format, which defines a duration and cyclic prefix of the preamble. In some examples, a RO may be associated with specific transmission beams (Tx beams) when the NE 102 uses beamforming. Accordingly, the UE 104 may select a RO corresponding to the beam it is synchronized with.

Accordingly, a respective UE 104 may receive the first and second RACH configurations and determine a first set of ROs based on the first RACH configuration, and a second set of ROs based on the second RACH configuration. In some examples, the UE 104 may acquire SIB1 which provides one or more RACH configurations. For example, a first RACH configuration may be associated with ROs for non-LPWA UEs, while a second RACH configuration may be associated with ROs for LPWA UEs. In certain examples, the UE 104 may determine the first and second sets of ROs using parameters in SIB1 and/or other system information (SI) broadcast by the NE 102. In other examples, the first set of ROs may be defined within the first RACH configuration and the second set of ROs may be defined within the second RACH configuration.

Based on the first and second sets of ROs, the UE 104 may determine a set of valid ROs that excludes the second set of ROs, where at least one RO of the set of valid ROs is associated with the first set of ROs. Note that the NE 102 may perform a similar determination of a set of valid ROs based on the first and second sets of ROs. Further, the UE 104 transmits—and the NE 102 receives—a RACH transmission in a RO of the set of valid ROs. As used herein, a “valid” RO refers to a specific RO where a UE is permitted to transmit a RACH message, such as RACH message 1 (Msg1) carrying a physical random access channel (PRACH) preamble, e.g., as part of the RACH procedure. To be valid, an RO must align with the numerology (e.g., subcarrier spacing) and frame structure of the wireless communication system 100. A valid RO must also correspond to the beam detected during synchronization and support the configured PRACH preamble format. According to aspects of the present disclosure, a valid RO of a non-LPWA UE may also be orthogonal to (i.e., non-overlapping with) the ROs configured for LPWA UEs, where the orthogonality corresponds to one or more of a time domain, a frequency domain, or a code domain. In other words, the non-LPWA UEs may be restricted (i.e., prohibited) from using any ROs configured for LPWA UEs.

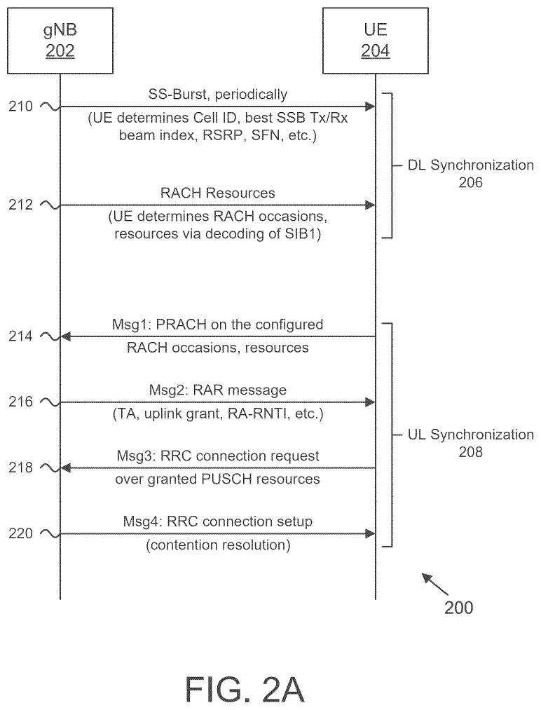

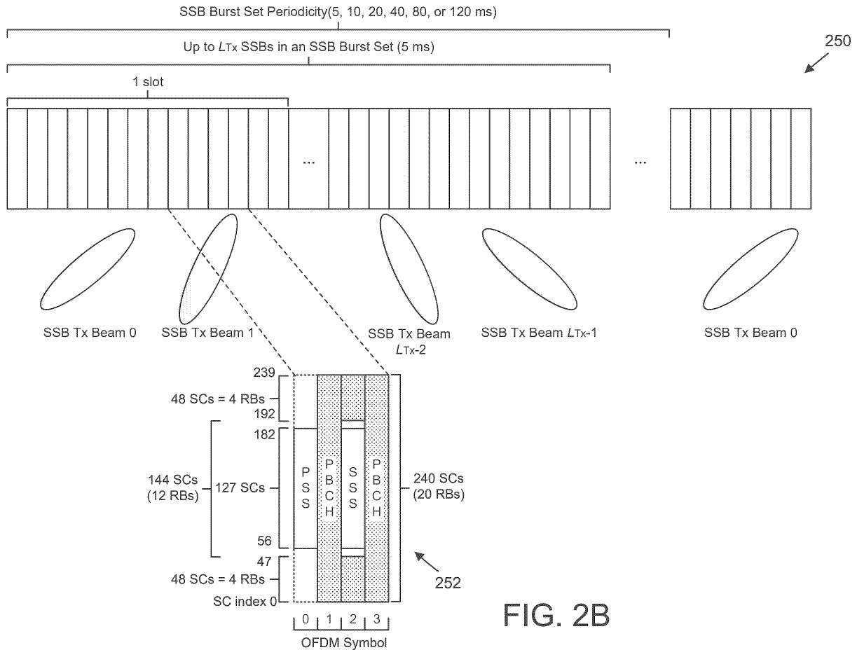

FIG. 2A illustrates an example of an initial access procedure 200 in accordance with aspects of the present disclosure. In 5G NR wireless communication systems, the UE 204 uses the initial access procedure to (re)synchronize itself with a serving network node (e.g., the gNB 202), (re)acquire the system information, and (re)establish a radio link.

For initial access, the UE 204 (e.g., an embodiment of the UE 104) detects a candidate cell via performing downlink (DL) synchronization procedure. For example, the gNB 202 (e.g., an embodiment of the NE 102) may transmit a synchronization signal/physical broadcast channel (SS/PBCH) transmission, also referred to as an SSB. The synchronization signal is a predefined sequence known to the UE 204 (or derivable using information already stored at the UE 204) and is in a predefined location in time relative to frame/subframe boundaries, etc. The UE 204 searches for the SSB and uses the SSB to obtain DL timing information (e.g., symbol timing) for the DL synchronization. The UE 204 may also decode system information (SI) based on the SSB. Note that with beam-based communication, each DL beam may be associated with a respective SSB.

During the DL synchronization step 206, the gNB 202 transmits a SSB burst, e.g., periodically (see signaling 210). The UE 204 measures and then selects the transmit beam (Tx beam) and receive beam (Rx beam) pair indices associated with the best SSB, where each SSB consists of the primary synchronization signal (PSS), the secondary synchronization signal (SSS), and the physical broadcast channel (PBCH). In certain embodiments, the UE 204 uses the PSS to synchronize in the frequency domain and uses the SSS to synchronize in the time domain. In certain embodiments, the PBCH carries basic system information (e.g., the MIB) needed for the UE 204 to begin communicating with the gNB 202.

After acquiring synchronization (and Cell-ID) and MIB (i.e., PBCH), the UE 204 determines (from the MIB) the location (i.e., in time and/or frequency) of the control resource set with index zero (CORESET #0). Then, the UE 204 searches the CORESET #0 to obtain system information block (SIB) type 1 (SIB1) information. The minimum number of RBs for CORESET #0 in 5G NR is 24 RBs.

The gNB 202 indicates the RACH resources, e.g., by transmitting SIB1 (see signaling 212). The SIB1 provides network access parameters (including random access parameters, such as RACH resources) along with scheduling information about all other system information. The SIB1 is carried by a broadcast physical downlink shared channel (PDSCH) transmission scheduled by a physical downlink control channel (PDCCH) transmission sent in the CORESET #0. In some examples, the SIB1 may be transmitted with a periodicity of 160 ms and may have variable transmission repetition periodicity within 160 ms. In some implementations, the timing and repetition pattern of SIB1 is indicated by PDCCHs scheduling SIB1 within the 160 ms period.

In 5G NR, the PDCCH carries control channel information, including downlink control information (DCI). The DCI bits (e.g., after medium access control (MAC) sublayer and physical (PHY) layer procedures including: CRC attachment, RNTI masking, interleaving, polar encoding, sub-block interleaving, rate-matching, scrambling, and QPSK modulation) are mapped to resource element groups (REGs), and 6 REGs are mapped to a control channel element (CCE); wherein a REG spans 1 RB in one symbol. In each REG, nine REs of the REG contain PDCCH payload, and the remaining three REs contain DMRS.

A UE performs blind detection/decoding of control channel candidates of a PDCCH monitoring occasion of a search space set; wherein each PDCCH candidate comprises one or multiple CCEs (also known as aggregation level (AL); with possible values of 1, 2, 4, 8, 16). A PDCCH with AL ‘L’ comprises ‘L’ contiguous CCEs (associated REGs can be in non-contiguous positions). The associated REGs belong to a control resource set (CORESET). As used herein, the CORESET refers to the time-frequency resources within a bandwidth part (BWP) where the PDCCH can be located. A cell may have multiple CORESETs. In some examples, each CORESET may be defined by several parameters, including the number of OFDM symbols, the frequency domain location, and the time domain allocation.

There are two types of CCE-to-REG mapping: interleaved and non-interleaved. In the case of interleave mapping, each CCE is composed of one or more REG bundles which are distributed in the frequency domain in units of REG bundles. A REG bundle is a set of indivisible resources consisting of neighboring REGs. A REG bundle spans across all OFDM symbols for the given CORESET. For non-interleaved CCE-to-REG mapping, all CCEs of a PDCCH with AL ‘L’ are mapped in consecutive REG bundles of the CORESET.

The resources for the CORESET are configured by RRC signaling except for CORESET 0. PDCCH can be precoded in a wideband manner or a narrowband manner. In wideband precoding, PDCCH DMRSs are transmitted in all contiguous REGs of a CORESET carrying the PDCCH using the same precoder. However, in narrow-band precoding, DMRS REs are transmitted only in the REG bundles actually used for the PDCCH transmission, and precoding is constant only within the REG bundle.

The CORESET #0 is a special CORESET which carries PDCCH/DCI for SIB1. The time-frequency resource of CORESET 0 is indicated by MIB which is carried by PBCH (as part of SSB). In 5G NR, CORESET 0 can have 24 or 48 RBs and 1-3 symbols in FR1.

After performing downlink DL synchronization and acquiring essential SI, such as the MIB and the SIB1, the UE 204 performs uplink (UL) synchronization and resource request by performing a random-access procedure, referred to as “RACH procedure,” and then transition to connected mode. The UE 204 determines RACH occasion (RO) resources, e.g., via decoding the SIB1.

In some examples, the parameters in SIB1 used to identify the valid RO resources include a PRACH configuration index that defines the periodicity and offset (in the time domain) for ROs. The UE 204 may use the PRACH configuration index to calculate subframes and OFDM symbols within a frame where the ROs are located and a periodicity of the ROs. In some examples, the parameters in SIB1 used to identify the valid RO resources include a PRACH frequency resource parameter that defines the frequency range for PRACH transmissions in the cell. The UE 204 may use the PRACH frequency resource parameter to determine the subcarriers or RBs where RACH messages can be transmitted.

As used herein, a RO refers to a time period (e.g., interval or scheduling window) during which the UE 204 is permitted to attempt to access the gNB 202 using a RACH procedure. Within a RO, there may be multiple PRACH resource occasions, depending on the system configuration. As used herein, a PRACH resource occasion refers to a specific set of time-frequency resources allocated for the UE to perform a PRACH transmission (i.e., transmit a PRACH preamble). For example, the PRACH resource occasion may correspond to specific RBs and subframes within a RO.

In 5G NR, the RACH related information conveyed via SIB1 includes, in part, the prach-ConfigurationIndex, the msg1-FDM, the msg1-FrequencyStart, and the ssb-perRACH-OccasionAndCB-PreamblesPerSSB.

The prach-ConfigurationIndex is a parameter that indicates which PRACH format is used and when to send PRACH in time domain, as well as the number of time domain ROs available and the corresponding periodicity. The msg1-FDM is a parameter that indicates the number of PRACH transmission occasions frequency division multiplexed (FDMed) in one time instance.

The msg1-FrequencyStart is a parameter that indicates the Offset of lowest PRACH transmission occasion in frequency domain with respect to the physical resource block (PRB) with zero index (PRB #0). The ssb-perRACH-OccasionAndCB-PreamblesPerSSB is a parameter that indicates the number of SSBs associated with each RO, and also the number of contention-based preambles per SSB.

During the (UL synchronization step 208, the UE 204 first selects a RACH preamble from the configured preamble pool associated with the selected SSB Tx beam and transmits a PRACH message (Msg1 or MsgA) using the identified SSB Rx beam over one or more of the ROs associated with the selected SSB Tx beam index (see signaling 214).

Regarding random access, two types of RACH procedure are supported in a 3GPP wireless communication network: A) a 4-step random-access (RA) type initiated by the sending of a RACH message 1 (Msg1) and 2-step RA type with RACH message A (MsgA). Both types of RACH procedure support contention-based random access (CBRA) and contention-free random access (CFRA).

The UE 204 selects the RA type at the initiation of the RACH procedure, e.g., based on network configuration. In one example, when CFRA resources are not configured, a reference signal received power (RSRP) threshold is used by the UE 204 to select between 2-step RA type and 4-step RA type. In another example, when CFRA resources for 4-step RA type are configured, the UE 204 performs random access with 4-step RA type. In another example, when CFRA resources for 2-step RA type are configured, the UE 204 performs random access with 2-step RA type.

Note that the network does not configure CFRA resources for 4-step and 2-step RA types at the same time for a bandwidth part (BWP). Additionally, the CFRA with 2-step RA type is only supported for handover.

The Msg1 of the 4-step RA type consists of a preamble transmitted on a PRACH. After the Msg1 transmission, the UE 204 monitors for a response from the network within a configured window. For CFRA, a dedicated preamble for Msg1 transmission is assigned by the network and upon receiving a random access response (RAR) from the network, the UE 204 ends the random access procedure. For CBRA, upon reception of the RAR (see signaling 216), the UE 204 sends a RACH message 3 (Msg3) using a UL grant scheduled in the RAR and monitors for contention resolution (see signaling 218). If contention resolution is successful, the gNB 202 transmits a RACH message 4 (Msg4) for RRC connection setup (see signaling 220). However, if the contention resolution is not successful after Msg3 (re)transmission(s), then the UE 204 goes back to Msg1 transmission.

The MsgA of the 2-step RA type includes a preamble on the PRACH and a payload on a physical uplink shared channel (PUSCH). After the MsgA transmission, the UE 204 monitors for a response from the network within a configured window. For CFRA, a dedicated preamble and PUSCH resource are configured for MsgA transmission and upon receiving the network response, the UE 204 ends the random access procedure. For CBRA, if contention resolution is successful upon receiving the network response, then the UE 204 ends the random access procedure; however, if a fallback indication is received in a RACH message B (MsgB), the UE 204 performs Msg3 transmission using the UL grant scheduled in the fallback indication and monitors for contention resolution. If contention resolution is not successful after Msg3 (re)transmission(s), the UE 204 goes back to MsgA transmission. If the random access procedure with 2-step RA type is not completed after a number of MsgA transmissions, the UE 204 can be configured to switch to CBRA with 4-step RA type.

FIG. 2B illustrates an example of an SSB burst set 250 comprising multiple SSB transmissions, in accordance with aspects of the present disclosure. For example, the gNB 202 may transmit the SSB burst set 250 with a periodicity, such as 5 ms, 10 ms, 20 ms, 40 ms, 80 ms, or 160 ms. Alternatively, the periodicity may be expressed in terms of slots, i.e., {5, 10, 20, 40, 80, 160} slots. There are up to L_{TX} SSBs in the SSB burst set 250, each associated with a different one of the L_{TX} DL beams.

The SSB burst set 250 containing multiple SSB transmissions, each associated with different realization of a transmission attribute such as different transmission beams. In some examples, the SSB burst set 250 assists a UE (e.g., the UE 204) to select the best realization of the transmission attribute. In 5G NR, the NE (e.g., gNB 202) may perform beamforming for each SSB transmission, e.g., to increase the coverage of the SSB signaling.

In some instances, the SSB burst set 250 is contained within a 5 ms (i.e., half-frame) time window. The distance between two consecutive SSB transmissions is such that there is sufficient time for the UE 204 to receive different beams. In the example of FIG. 2B, two SSB transmissions are performed in a slot. For 15 KHz SCS, the first SSB starts at symbol 2 and the second SSB starts at symbol 8, and this repeats two times for carrier frequencies less than or equal to 3 GHz, and may repeat four times for carrier frequencies between 3 GHz and 6 GHz.

A respective SSB transmission 252 (also referred to as a SS/PBCH transmission) includes the PSS, the SSS, and the PBCH. In the depicted embodiment, the SSB transmission duration is 4 OFDM symbols in the time domain, with the PSS and SSS each transmitted over 1 OFDM symbol, and the PBCH is transmitted over 3 OFDM symbols.

In 5G NR, the SSB transmission 252 spans 240 subcarriers, e.g., 20 resource block (RBs), in the frequency domain. The PSS and SSS span 127 subcarriers at the center of the SSB transmission 252. In the second and fourth OFDM symbols, the PBCH spans 240 subcarriers, while in the third OFDM symbol, the PBCH covers the 48 lowest subcarriers and the 48 highest subcarriers of the SSB transmission 252.

In 5G NR, the RB typically spans 12 subcarriers, and the bandwidth of the RB depends on the SCS used in the 5G NR system. For example, for 15 kHz SCS, the bandwidth of one RB is 180 kHz, while for 30 kHz SCS, the bandwidth of one RB is 360 kHz. Similarly, for 60 kHz SCS, the bandwidth of one RB is 720 kHz, while for 120 kHz SCS, the bandwidth of one RB is 1.44 MHz.

The duration of an RB in time is one slot, which may be composed of, e.g., 14 OFDM symbols in the time domain. In 5G NR, the time duration of an RB is based on the slot duration, which may vary according to the numerology and SCS used. For example, for 15 kHz SCS, the time duration of one RB (i.e., slot duration) is 1 ms, while for 30 kHz SCS, the time duration of one RB (slot duration) is 0.5 ms. Similarly, for 60 kHz SCS, the time duration of one RB (i.e., slot duration) is 0.25 ms, while for 120 kHz SCS, the time duration of one RB (slot duration) is 0.125 ms.

For 5G NR, the starting symbols and number of SSB blocks as function of system carrier frequency and SCS are defined in 3GPP technical specification (TS) 38.213.

Currently in 5G NR, PBCH payload is at most 32 bits and are appended by 24 bits CRC. The polar encoded stream would have 512 bits, and after rate matching it ends up having 864 bits. Using QPSK, 432 resource elements (REs) are needed. Further, the demodulation reference signal (DMRS) occupies 144 additional REs, leading to 144×4 REs for the PBCH transmission. Note that an RE in 5G NR is a combination of one subcarrier in the frequency domain and one OFDM symbol in the time domain.

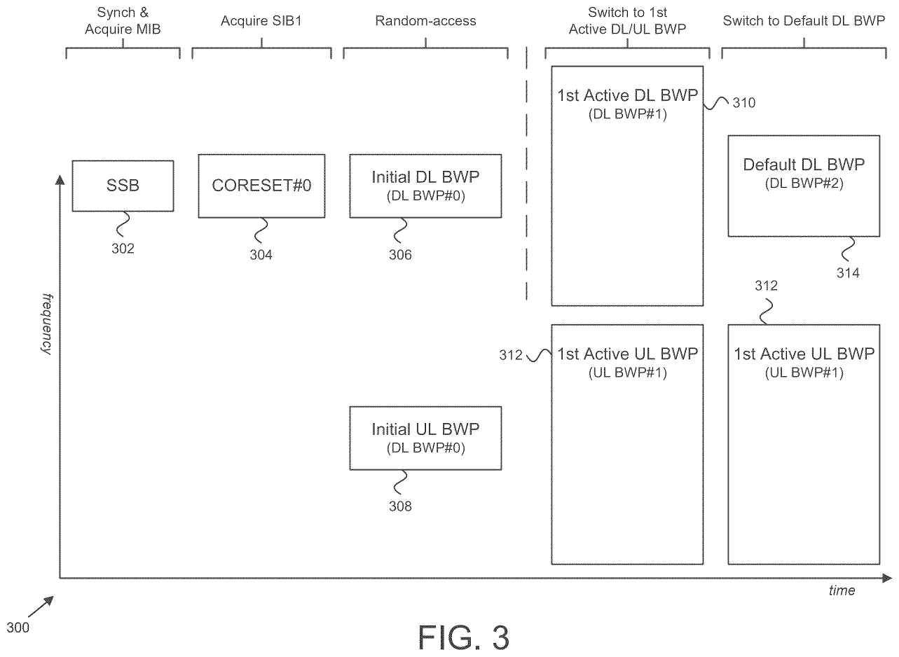

FIG. 3 illustrates an example of a transmission diagram 300 in accordance with aspects of the present disclosure. In some examples, the transmission diagram 300 implements or is implemented by aspects of the wireless communications system 100. For example, the transmission diagram 300 can be implemented by a UE and a NE, which may be examples of a UE 104 and a NE 102, e.g., as described with reference to FIG. 1. The NE and/or the UE can operate in one or more modes, including an active mode and an inactive mode, to reduce power consumptions of the NE and/or the UE.

In some examples, a NE and a UE can transmit and receive signaling, such as control signaling and/or data. The NE and the UE can transmit and receive the signaling via one or more communication links. For example, the NE can transmit signaling to the UE via a downlink communication link, while the UE can transmit signaling to the NE via an uplink communication link. The signaling can occupy one or more time-frequency resources, which can also be referred to as communication resources or resources. For example, the NE and/or the UE can transmit signaling using one or more radio frames. A radio frame can be further divided into smaller units of time, such as slots or occasions. The NE and/or the UE can transmit the signaling using one or more frequency resources, including, but not limited to, frequency bands, component carriers (CCs), bandwidth parts (BWPs), among other example frequency resources.

For example, the NE can periodically broadcast one or more SSBs and SIBs to UEs within a coverage area of the NE, e.g., for cell identification, idle mode mobility, connected mode mobility, etc. As described above, the SSBs include information for the UEs to perform time and frequency synchronization with the NE for reception of system information (e.g., the SIB1). A PBCH can include a MIB that indicates a system frame number (SFN), a subcarrier spacing, a bandwidth, among other information for reception of a SIB1. In 5G NR, PBCH Data may arrive to the coding unit in the form of a maximum of one transport block every 80 ms.

After acquiring SIB1, the UE can perform random access, and then transition to connected mode. Moreover, the UE may use different BWPs throughout operation: starting from initial BWP during random access to active BWP (which can be chosen from a set of configured BWPs), and default BWP when a timer expires.

In some examples, the NE may configure a UE with a BWP for initial access to a cell. A BWP refers to a particular subset of the overall channel bandwidth within a carrier, allowing for flexible and efficient use of the frequency resources within the carrier. Additionally, energy saving is achieved by operating on a smaller BWP when full bandwidth is not needed, thereby reducing power consumption for transmitting and receiving/decoding signals. For example, the NE may dynamically enable a respective BWP based on user demand and/or network conditions. In some examples, the BWP may consist of at least one DL BWP and at least one UL BWP.

Moreover, for initial access to the cell, the UE may be configured with a set of default parameters that defines the initial BWP, i.e., the BWP that the UE uses to perform initial access procedures, e.g., when entering a cell or transitioning to the RRC_Connected mode. Initial access procedures include, but are not limited to, cell search, synchronization, random access, and connection establishment.

In various implementations, the initial DL and UL BWPs are used at least for initial access before radio resource control (RRC) connection is established. An initial BWP has index zero and is referred to as BWP #0. The initial BWP carries essential common channels and signals required for initial access, such as the PDCCH, the physical downlink shared channel (PDSCH), the physical random access channel (PRACH), and the SIBs.

During the initial access, the UE performs cell search based on a SSB composed of the primary synchronization signal (PSS), the secondary synchronization signal (SSS), and the PBCH. To access the system, the UE needs to further read the SIB1, which carries important information including the initial DL/UL BWP configuration. The SIB1 is transmitted on the PDSCH, which is scheduled by downlink control information (DCI) on the PDCCH using the CORESET #0.

Before the UE reads the SIB1, the UE's initial DL BWP has the same frequency range and numerology as those of CORESET #0. After reading the SIB1 (which may be broadcast in CORESET #0), the UE follows the initial DL/UL BWP configuration in the SIB1 and uses the initial DL/UL BWP to carry out RACH procedure to request the setup of RRC connection. In some examples, the NE configures the frequency domain location and bandwidth of the initial DL BWP in the SIB1 so that the initial DL BWP contains the entire CORESET #0 in the frequency domain.

FIG. 3 illustrates an exemplary transmission diagram 300 for the BWP operation of a 5G device, in accordance with aspects of the present disclosure. In some examples, the transmission diagram 300 is implemented by aspects of the wireless communications system 100, for example, implemented by a UE and a NE, which may be examples of a UE 104 and a NE 102 as described with reference to FIG. 1.

As shown in FIG. 3, the initial BWP operation may include transmission of the SSB 302, e.g., over 20 resource blocks (RBs). In certain examples, the SSB 302 may be an embodiment of the SSB transmission 252, and may comprise one or more SSB transmissions 252 of a SSB burst set 250. In addition to the SSB 302, the initial BWP operation may include the transmission of the CORESET #0 304, e.g., over 24 RBs. Additionally, the initial BWP operation may include transmissions over the initial BWP 306, comprising the initial DL BWP 306 and the initial UL BWP 308. In the example of FIG. 3, the initial DL BWP 306 (also referred to as DL BWP #0) spans 24 RBs and the initial UL BWP 308 (also referred to as UL BWP #0) also spans 24 RBs, e.g., according to the configuration indicated in SIB1.

Upon completion of the RACH procedure, the UE transitions from idle mode to a connected mode. Additionally, an active BWP operation may include transmission of an RRC configuration to the UE that defines (i.e., configures) a set of one or more BWPs. Further, the UE may receive an indication to activate a first BWP (e.g., a first active DL BWP and a first active UL BWP). Note that the BWP that is currently in use is referred to as the active BWP, while those BWPs that are configured but not currently in use are referred to as inactive BWPs.

While in the connected mode, the UE may switch from one active BWP to another (e.g., switching DL BWPs, UL BWPs, or both) in response to an indication or reconfiguration from the NE, or in response to expiration of an inactivity timer. In the example of FIG. 3, the first active DL BWP 310 (also referred to as DL BWP #1) spans 270 RBs and the first active UL BWP 312 (also referred to as UL BWP #1) also spans 270 RBs, e.g., according to the RRC configuration.

To reduce power consumption, after a period of inactivity the UE and NE may switch to a default DL BWP. For example, the NE may configure the UE with an inactivity timer which is reset when a data transmission (e.g., uplink or downlink) occurs. The value of the inactivity timer is a network-configured parameter selected to balance power savings, resource optimization, and service quality. Upon expiry of the inactivity timer, the UE switches to the default DL BWP. In the example of FIG. 3, the default DL BWP 314 (also referred to as DL BWP #1) spans 52 RBs, e.g., according to the RRC configuration.

Certain wireless communication systems may support UEs with different bandwidth capabilities, including LPWA UEs (also referred to as bandwidth limited UEs (BL-UEs)) and non-LPWA UEs (also referred to as wideband UEs (WB-UEs)).

To improve network energy savings, the present disclosure describes a RACH design for cells serving low power wide area (LPWA) IoT communications, wherein non-LPWA UEs determine RACH configurations and ROs having resources that are orthogonal to the RO resources utilized by LPWA UEs in a cell. The RACH design enables the UEs (e.g., both LPWA UEs and non-LPWA UEs) to perform RACH procedure in an efficient manner in the cell.

In the following descriptions, it is assumed that a RO occupies a number of RBs ‘T’, wherein ‘T’ is not larger than the operation BW of a LPWA UE. For example, a LWPA UE with an operational BW limited to 12 RBs (e.g., 144 subcarriers) may be to have T=12 RBs, and have short preamble for RACH operation.

In the following descriptions, it is also assumed that a RACH occasion (RO) is associated with a set of time-frequency resources and a set of preambles unless otherwise stated.

In one implementation, the ROs for non-LPWA and LPWA UEs may be the same. In another implementation, the ROs for non-LPWA and LPWA UEs may be different than each other. In other implementation, the ROs for non-LPWA UEs and LPWA UEs may be a subset of the other.

In some examples, due to the limited BW of LPWA UEs, sharing the same ROs with non-LPWA UEs may limit the frequency multiplexing of RACH resources (e.g., up to two RACH resources can be multiplexed in the frequency domain). In further examples, sharing the same ROs may force both UE types (i.e., non-LPWA UEs and LPWA UEs) to not support FDM for RACH operation.

In some examples, having ROs of LPWA UE being a subset of ROs of non-LPWA UEs could affect the association of SSB-to-RO. In 5G NR, different SSB transmissions may be associated with different beams, and the UE may select a certain beam and send PRACH using that beam, as described above. In order for the network (e.g., NE) to determine which beam UE has selected, a specific mapping may be defined between a SSB transmission (e.g., SSB beam) and a RO. By detecting in which RO the UE has transmitted the PRACH preamble, the NE can determine which SSB beam that UE has selected.

In some examples, different ROs for LPWA and non-LPWA UEs may be orthogonal, i.e., non-overlapping in at least one of time, frequency, code, or preamble domains. Orthogonal RACH resources can be achieved via orthogonal time and/or frequency resources or via separate sets of preambles. How the orthogonality is ensured by network may be specified, e.g., in standards. For example, the network (e.g., NE) may inform non-LPWA UEs regarding ROs of LPWA UEs, and those occasions will not be used by non-LPWA UEs if those occasions overlap with those of non-LPWA UEs. In other words, the LPWA UEs may determine and use a set of valid ROs that are orthogonal to ROs of LPWA UEs.

In some examples, one or more ROs for LPWA and non-LPWA UEs may be overlapping. For example, overlapping ROs may be permitted during certain conditions, such as a low network load. However, the overlapping ROs may need to be associated with the same SSB index, even if the overlapping ROs belong to different RACH configurations. Accordingly, the network may enforce the associations of SSB-to-RO for different RACH configurations to ensure that overlapping ROs are associated with the same SSB index.

According to aspects of a first solution, the ROs of LPWA UEs and non-LPWA UEs may be based on a dedicated BWP. In one implementation, a LPWA UE (e.g., an IoT-type UE) may receive a dedicated UL BWP and a first RACH configuration, e.g., via SIB1 indication. The LPWA UE may transmit a RACH transmission within the dedicated UL BWP.

A non-LPWA UE may also receive information regarding the dedicated UL BWP (e.g., via the same SIB1 indication or a different SIB1 indication), and an indication of a set of time instances. The non-LPWA UE may additionally receive a second RACH configuration (which may be the same as or different than the first RACH configuration). Accordingly, the non-LPWA UE determines its ROs based on the second RACH configuration and the information regarding the dedicated UL BWP.

In some examples, the non-LPWA UE may determine a valid set of ROs by excluding the ROs associated with the second RACH configuration that overlap with the dedicated UL BWP, e.g., when the ROs occur within the indicated set of time instances. Note that the first RO may include only frequency resources within the dedicated UL BWP, accordingly, the non-LPWA UE may determine a valid set of ROs by excluding the ROs associated with the second RACH configuration that overlap with any RO associated with the first RACH configuration.

In some examples, the non-LPWA UE may determine a frequency domain spacing amongst FDMed ROs based on dedicated UL BWP, e.g., when the ROs occur within the indicated set of time instances. As used herein, the frequency domain spacing refers to a separation or distance in the frequency domain between ROs, e.g., defined relative to a lowest indexed RB or subcarrier of a respective RO and the lowest indexed RB or subcarrier of the next closest valid RO of the same time instance.

In some examples, the non-LPWA UE may determine a subset of the possible set of preambles to be used in its ROs. Accordingly, whenever the non-LPWA UE uses a RO that overlaps with the dedicated UL BWP, then the non-LPWA UE will use a preamble from the determined subset for the ROs, e.g., when the overlapping ROs occur within the indicated set of time instances.

In a related implementation, the dedicated UL BWP may be larger than the maximum operating BW of the LWPA UE. Accordingly, the LPWA UE may determine a subset of the UL BWP for its ROs and corresponding RACH transmissions; wherein the subset is not larger than its operating BW.

In some examples, the dedicated UL BWP may span 24 RBs in the frequency domain, wherein the maximum operating BW of the LPWA UE is 12 RBs. In one such an implementation, the LPWA UE may consider the first 12 RBs (i.e., the 12 lowest RBs in frequency) of the dedicated UL BWP to be a first candidate BWP, and consider the second 12 RBs (i.e., the 12 highest RBs in frequency of the dedicated UL BWP) to be a second candidate BWP. Based on a selection criteria, the LPWA UE selects either the first 12 RBs or the second 12 RBs. In some examples, the LPWA UE may randomly select the first or the second 12 RBs.

In another related implementation, the dedicated UL BWP may be a first multiple of a reference BW size; wherein the reference BW size is a fraction of maximum operating BW of LPWA UE. As an example, the reference BW size may be 12 RBs, the dedicated UL BWP may span 48 RBs,, and the maximum operating BW of the LPWA UE is 24 RBs. In this example, the first multiple is ‘4’.

The LPWA UE, based on a selection criteria and/or based on a network indication (such as an SIB1 indication), determines a second multiple of the reference BW size; wherein the second multiple is smaller than the first multiple. According to the above example, the second multiple is selected from ‘1’ or ‘2’, with ‘2’ being the largest possible value of the second multiple due to the reference BW size being half the maximum operating BW of the LPWA UE. Upon determination of the second multiple, the LPWA UE can transmit a RACH transmission within the subset of the dedicated UL BWP defined by the second multiple.

According to aspects of a second solution, the LPWA UEs and non-LPWA UEs may determine a set of valid ROs based on the same RACH configuration. In one implementation, if both types of UEs (i.e., LPWA and non-LPWA UEs) receive the same SIB1 signal with a common (i.e., same) RACH configuration applicable to both types of UE, then the non-LPWA UEs may determine their ROs according to legacy procedures. However, in such implementations, the LPWA UEs may determine their valid ROs to be only a subset of the ROs associated with the common RACH configuration.

In some examples, an LPWA UE may ignore a parameter that indicates how many ROs are to be FDMed in a time unit (e.g., slot, sub-slot, or set of OFDM symbols. In 5G NR, the parameter msg1-FDM indicates how many ROs are to be FDMed in a time unit. Note that the non-LPWA UE would not ignore this parameter and would take into account the actual value of the parameter when determining their ROs.

In other examples, the LPWA UE may consider the parameter to be set to 1 (e.g., msg1-FDM=1) or another value that indicates that ROs are not FDMed in the same set of symbols. Alternatively, the LPWA UE may consider the FDM capability to be at most a certain value (e.g., 2) if it gets a configuration that has a larger FDM multiplexing than that value (e.g., 3). In other words, a configuration that has a larger FDM multiplexing than what is supported by the LPWA UE would be treated as if the configuration indicates the largest FDM multiplexing supported by the LPWA UE.

However, such determination according to the second solution could potentially lead to different SSB-to-RO associations for non-LPWA and LPWA UEs. Alternatively, implementation of the second solution could limit the number of SSBs and/or RACH preambles which can be mapped to a RO for an LPWA UE. As described above, the network may enforce the associations of SSB-to-RO for different RACH configurations to ensure that overlapping ROs are associated with the same SSB index.

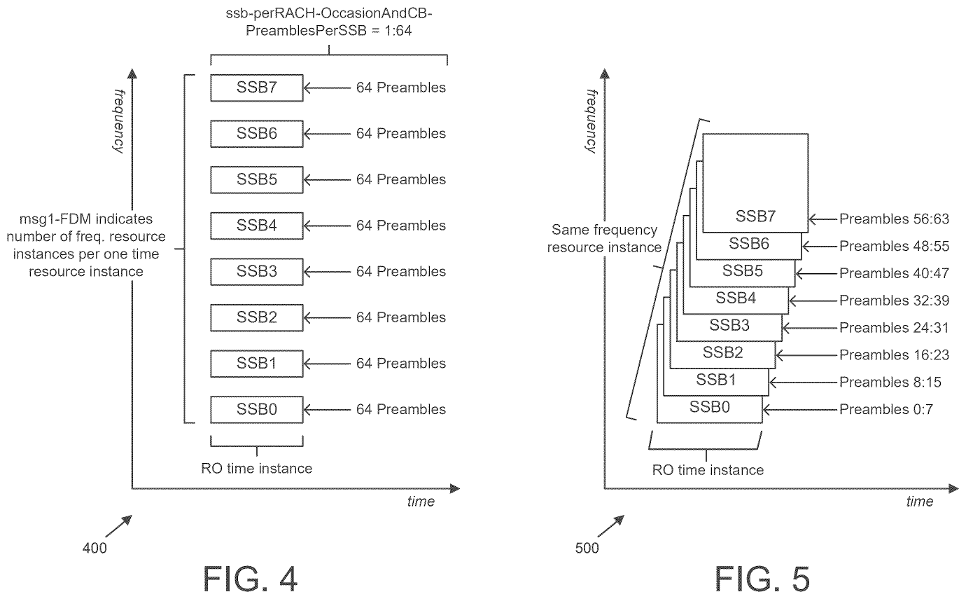

FIG. 4 illustrates an example of mapping 400 SSB beams and RACH preambles to ROs (e.g., for non-LPWA UE), in accordance with aspects of the present disclosure. In some examples, the mapping 400 is implemented by aspects of the wireless communications system 100, for example, implemented by a UE and a NE, which may be examples of a UE 104 and a NE 102 as described with reference to FIG. 1.

As shown in FIG. 4, the RO consists of one time resource instance and eight frequency resource instances. The depicted example assumes that the value of parameter msg1-FDM=8, the number of SSBs is 8 (i.e., from SSB0 to SSB7), and the value of parameter ssb-perRACH-OccasionAndCB-PreamblesPerSSB is {1, n64} (i.e., one-to-64). Accordingly, each SSB index is mapped to one frequency resource, and all 64 preambles are possible in all of the eight FDMed RACH resources.

Having selected the best SSB beam, the non-LPWA UE determines the SSB and preamble mapping to ROs according to the example of FIG. 4, wherein the frequency resource instance is based on the selected SSB, and the non-LPWA UE determines a RACH preamble to use from any of the 64 RACH preambles. Accordingly, to perform initial access to the cell associated with the SS transmissions, the non-LPWA UE transmits a RACH transmission (e.g., a Msg1 or a MsgA) comprising the selected RACH preamble using the frequency resource instance selected based on the SSB and during the RO time resource instance.

FIG. 5 illustrates another example of mapping 500 SSB beams and RACH preambles to ROs (e.g., for LPWA UE), in accordance with aspects of the present disclosure. In some examples, the mapping 500 is implemented by aspects of the wireless communications system 100, for example, implemented by a UE and a NE, which may be examples of a UE 104 and a NE 102 as described with reference to FIG. 1.

As shown in FIG. 5, the RO consists of one time resource instance and one frequency resource instance. The depicted example assumes that the value of parameter msg1-FDM=8, the number of SSBs is 8 (i.e., from SSB0 to SSB7), and the value of parameter ssb-perRACH-OccasionAndCB-PreamblesPerSSB is {1, n64} (i.e., one-to-64) for a non-LPWA UE. Only one RO out of 8 ROs multiplexed in frequency is shown in this figure.

However, it is further assumed that when the UE is a LPWA UE, it considers the parameter to be set to 1 (e.g., msg1-FDM=1), and hence only considers the RO, and not the ones multiplexed in frequency with the shown RO for RACH transmissions. Accordingly, for the LPWA UE each SSB index is mapped to that same frequency resource instance, and all 64 preambles are possible in the frequency resource.

The LPWA UE determines the SSB and preamble mapping to ROs by distributing preambles to SSBs. Consequently, the eight different SSB indices are mapped to eight ROs which share the same time and frequency resources, but distinguished by different RACH preambles. In the depicted example, eight RACH preambles are mapped each occasion associated with an SSB index.

For instance, the first 8 RACH preambles (e.g., preamble index 0 to preamble index 7) are associated with SSB0, the second 8 preambles (e.g., preamble index 8 to preamble index 15) are associated with SSB1, the next 8 preambles (e.g., preamble index 16 to preamble index 23) are associated with SSB2, the next 8 preambles (e.g., preamble index 24 to preamble index 31) are associated with SSB3, the next 8 preambles (e.g., preamble index 32 to preamble index 39) are associated with SSB4, the next 8 preambles (e.g., preamble index 40 to preamble index 47) are associated with SSB5, the next 8 preambles (e.g., preamble index 48 to preamble index 55) are associated with SSB6, and the last 8 preambles (e.g., preamble index 56 to preamble index 63) are associated with SSB7. The non-LPWA UE also can follow the same preamble distribution for RACH transmission in this time frequency resource.

Having selected the best SSB beam, the LPWA UE determines the SSB and preamble mapping to ROs according to the example of FIG. 5, wherein the non-LPWA UE determines a RACH preamble to use from the subset of RACH preambles associated with the selected SSB. Accordingly, to perform initial access to the cell associated with the SSB transmissions, the LPWA UE transmits a RACH transmission (e.g., a Msg1 or MsgA transmission) comprising the selected RACH preamble using the common frequency resource instance and during the RO time resource instance.

Note in the embodiment of FIG. 5, a non-LPWA UE that selects SSB0 as its best SSB beam would transmit its Msg1 using the same frequency resource instance and the same time resource instance as a LPWA UE. To ensure consistent mapping of SSB-to-RO, the non-LPWA UE must use only a RACH preamble from the same subset of preambles associated with SSB0 by the LPWA UE, i.e., only the first 8 preambles are possible to be used by both non-LPWA UEs and LPWA UEs in the first frequency resource in accordance with the example of FIG. 5.

Accordingly, the non-LPWA UEs need to know whether such preamble restriction is applicable or not to the occasions corresponding to the first frequency resource. For instance, the SIB1 may indicate whether such restriction is applicable.

In an alternate implementation, where the value of parameter msg1-FDM=8, the number of SSBs is 8 (i.e., from SSB0 to SSB7), and the value of parameter ssb-perRACH-OccasionAndCB-PreamblesPerSSB is {1, n64} (i.e., one-to-64), the LPWA UE may determine the SSB and preamble mapping to ROs by having one SSB index (e.g., SSB0) associated with its ROs.

Alternatively, the LPWA UE can cycle amongst SSB indices in different SSB bursts (only 1 SSB index per burst associated with the time-frequency resource of the RO). Using the latter approach does not allow SSB combining over multiple consecutive SSB bursts; however, the LPWA UE may still combine SSBs over, e.g., every 8 SSB bursts if there are 8 SSB indices/beams possible.

In an alternative implementation, the LPWA UE determines its ROs by shifting the applicable occasions of non-LPWA UE in time or in frequency, e.g., the next valid slot is used to carry LPWA ROs. Accordingly, the LPWA UE may determine an alternative set of time resources (e.g., next valid slot) or an alternative set of frequency resources (e.g., a different FDMed RO) based on a determined overlap between ROs for LPWA UEs and ROs for non-LPWA UEs.

In some implementations, the network may transmit the same RACH configuration for both types of UE (i.e., LPWA UEs and non-LPWA UEs) using two different SIB1 transmissions (e.g., associated with different CORESET #0s) that contain the same RACH configuration.

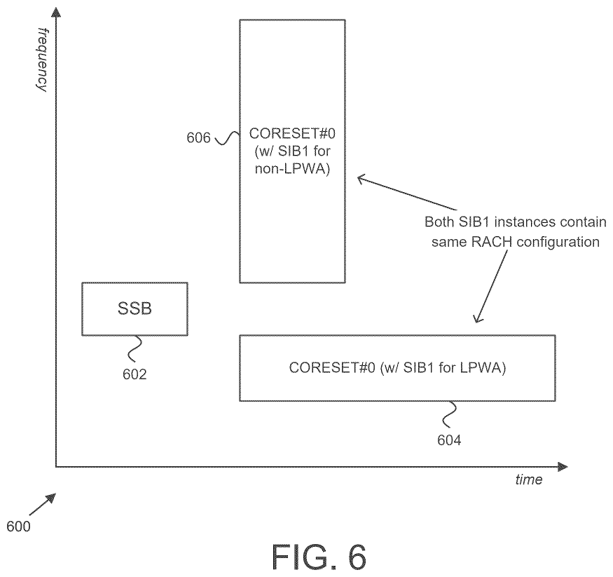

FIG. 6 illustrates an exemplary transmission diagram 600 for different SIB1 transmissions, in accordance with aspects of the present disclosure. In some examples, the transmission diagram 600 is implemented by aspects of the wireless communications system 100, for example, implemented by a UE and a NE, which may be examples of a UE 104 and a NE 102 as described with reference to FIG. 1.

As shown in FIG. 6, the SIB1 operation includes different SIB1 transmissions associated with different CORESET #0s, including transmission of the SSB 602, e.g., over 12 RBs, which points to a first CORESET #0 instance 604 and a second CORESET #0 instance 606. The SIB1 operation may include the transmission of the first CORESET #0 instance 604 over 48 RBs for reception by non-LPWA UEs. Here it is assumed that 48 RBs exceeds the maximum operating BW of the LPWAs.

Additionally, the SIB1 operation may include the transmission of the second CORESET #0 instance 606 over 12 RBs for reception by non-LPWA UEs. Here it is assumed that 12 RBs is within the maximum operating BW of the LPWAs. Note that the second CORESET #0 instance 606 uses more time domain resources compared to the first CORESET #0 instance 604 in order to carry the SIB1 containing the RACH configuration.

In some examples, if the NE transmits the same RACH configuration for both UE types using different SIB1 transmissions (i.e., one SIB1 transmission associated with each UE type, and the different SIB1s containing the same RACH configuration), then the non-LPWA UE may be provided with the SIB1 transmission information associated with LPWA UE as well as its own SIB1 transmission information.

In some embodiments, a non-LPWA UE is aware of both CORESET #0s for LPWA UEs and non-LPWA UEs, and may start monitoring the second CORESET #0 instance 606 for LPWA UEs after multiple consecutive failures of monitoring/detecting a PDCCH candidate in the first CORESET #0 instance 604.

In a related embodiment, the network (e.g., NE) may indicate or configure (e.g., via RRC signaling) that if the reference signal received power (RSRP) of a non-LPWA UE is less than a threshold at least for a certain duration of time, then the non-LPWA UE should switch from monitoring the first CORESET #0 instance 604 to monitoring the second CORESET #0 instance 606. In some examples, such an indication may be an indication in SIB1 or an RRC indication.

In another implementation, some non-LPWA UEs may decode PDCCH candidates associated with both the first CORESET #0 instance 604 for non-LPWA UEs and the second CORESET #0 instance 606 CORESET0s for LPWA UEs and both corresponding SIB1 PDSCHs.

According to aspects of a third solution, if a SIB1 is applicable to both UE types, then the network may implement signaling optimization, e.g., to reduce SIB1 overhead may be possible especially considering the BW limitation of the LPWA UEs. In some examples, some RACH configuration parameters might be the same for both UE types, and some might be different.

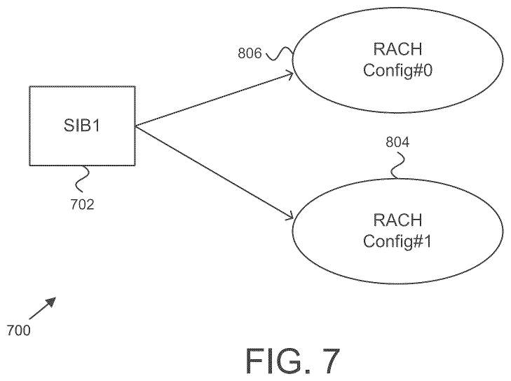

FIG. 7 illustrates an exemplary diagram 700 for determining different RACH configurations from a SIB1 transmission, in accordance with aspects of the present disclosure. In some examples, the diagram 700 is implemented by aspects of the wireless communications system 100, for example, implemented by a UE and a NE, which may be examples of a UE 104 and a NE 102 as described with reference to FIG. 1.

As shown in FIG. 7, the SIB1 includes information about a first RACH configuration (e.g., RACH Config0) associated with LPWA UEs and a second RACH configuration (e.g., RACH Config1) associated with non-LPWA UEs. In one embodiment, the SIB1 may include the first RACH configuration (e.g., associated with LPWA UEs) and also include a set of different parameters, whereby the non-LPWA UEs may derive the second RACH configuration by applying the set of different parameters to the first RACH configuration. In one embodiment, the different parameters may include: msg1-FrequencyStart, ssb-perRACH-OccasionAndCB-PreamblesPerSSB.

According to aspects of a fourth solution, if the LPWA UEs monitor a different CORESET #0 than the non-LPWA UEs in a cell, then the different types of UEs can be scheduled with potentially different SIB1s, and hence each UE type may receive its own RACH configuration.

The network may set the RACH configurations such that the overlap between the RACH resources of the two types is minimized. For example, the ROs of the two UE types occur in different time instances/slots, and at least there is certain time gap between adjacent ROs of the two UE types, e.g., to take care of maximum time advance possible in the cell. In certain embodiments, there may be other restrictions such as on not allowing certain combination of preamble formats associated with the two UE types.

In some embodiments, in addition to the RACH configuration for non-LPWA UEs, the SIB1 transmissions for non-LPWA UEs provide one or more of the following: A) Information about non-LPWA UE's ROs which should be skipped; B) Information about non-LPWA UE's ROs (i.e., overlapping with LPWA UE's ROs in time and/or frequency) for which a pre-defined/determined first set of RACH preambles are to be used, wherein the first set of RACH preambles are different than a second set of RACH preambles which would have been applicable to the overlapping ROs according to the RACH configuration of the non-LPWA UEs; or C) Information regarding the RACH configuration of LPWA UEs; or a combination thereof.

Concerning the information regarding the RACH configuration of LPWA UEs, in some examples there may be several RACH configurations for LPWA UEs (e.g., if different UE groups are assigned different RACH configurations, e.g., on different portion of the system/cell BW).

In some examples, the information regarding the RACH configuration of LPWA UEs may include information based on which, the non-LPWA UE can determine ROs of LPWA UEs in the cell. For instance, such information may include values for the parameters, prach-ConfigurationIndex, msg1-FDM, msg1-FrequencyStart, totalNumberOfRA-Preambles, ssb-perRACH-OccasionAndCB-PreamblesPerSSB, or a combination thereof.

In some embodiments, the SIB1 transmissions associated with non-LPWA UEs may contain information of one or more of RACH configuration(s) (such as similar to the information elements (IEs) RACH-ConfigCommon or RACH-ConfigGeneric, or time instances of ROs) associated with LPWA UEs. In such embodiments, the non-LPWA UEs may determine their valid set of ROs based on the received RACH configuration associated with the non-LPWA UEs and further based on RACH configuration(s) associated with the LPWA UEs.

In a first example, a non-LPWA UE determines a spacing between ROs multiplexed in frequency domain such that it avoids overlap with ROs of LPWA UEs.

In a second example, the SIB1 for non-LPWA UEs indicates a first offset, and a second offset of lowest PRACH transmission occasion in frequency domain with respect to a reference PRB such as PRB 0; wherein the ROs of the non-LPWA UEs are determined based on the first offset and the second offset. In an example, the first offset is associated with nominal ROs of non-LPWA UEs, and the second offset is associated with nominal ROs of LPWA UEs. In addition to the offset, the SIB1 for non-LPWA UEs may also indicate RACH configuration index of LPWA UEs.

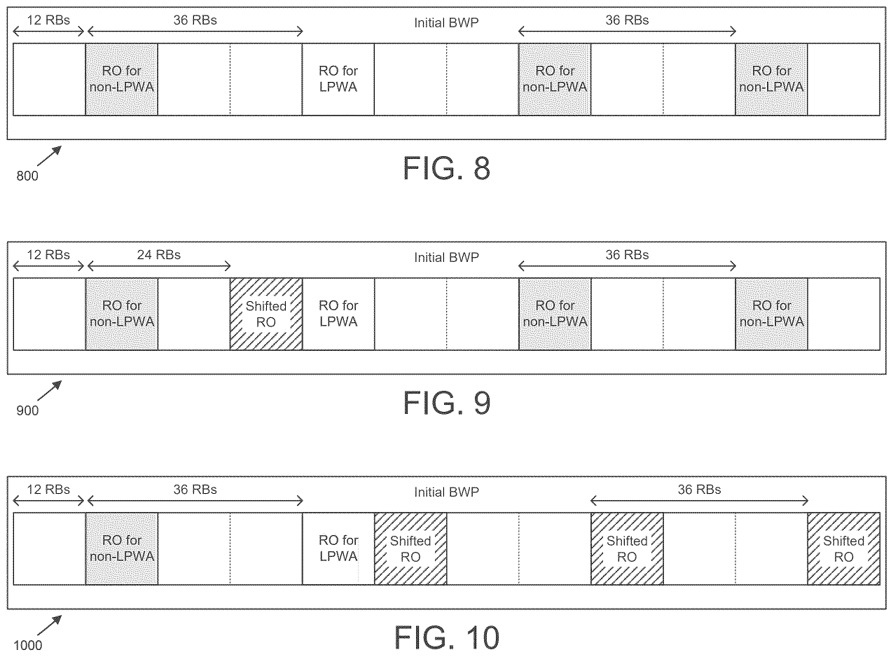

FIG. 8 illustrates an example of a first allocation scheme 800 for ROs of LPWA UEs and non-LPWA UEs, in accordance with aspects of the present disclosure. In some examples, the first allocation scheme 800 is implemented by aspects of the wireless communications system 100, for example, implemented by a UE and a NE, which may be examples of a UE 104 and a NE 102 as described with reference to FIG. 1.

In the example of FIG. 8, the network (e.g., NE) may indicate a first set of ROs for non-LPWA UEs, and a second set of ROs for LPWA UEs. The first set of ROs for non-LPWA UEs comprises a first frequency resource instance offset by 12 RBs from the initial BWP, and subsequent frequency resource instances spaced 36 RBs from the first frequency resource instance. The second set of ROs for LPWA UEs comprises a frequency resource instance offset by 48 RBs from the initial BWP; accordingly, there is an overlap at the RO offset by 48 RBs from the initial BWP which is an RO common to both the first and second sets of ROs.

As shown in FIG. 8, to resolve the overlap the non-LPWA UEs may omit the second RO of first set of ROs due to overlap with the RO of the LPWA UE. Alternatively, the non-LPWA UEs may declare the second RO to be not valid. In other words, the non-LPWA UEs may determine a third set of valid ROs that includes the non-overlapping ROs from the first set of ROs and does not include any ROs from the second set of ROs.

FIG. 9 illustrates an example of a second allocation scheme 900 for ROs of LPWA UEs and non-LPWA UEs, in accordance with aspects of the present disclosure. In some examples, the second allocation scheme 900 is implemented by aspects of the wireless communications system 100, for example, implemented by a UE and a NE, which may be examples of a UE 104 and a NE 102, e.g., as described with reference to FIG. 1.

In the example of FIG. 9, the network (e.g., NE) may indicate a first set of ROs for non-LPWA UEs, and a second set of ROs for LPWA UEs. The first set of ROs for non-LPWA UEs comprises a first frequency resource instance offset by 12 RBs from the initial BWP, and subsequent frequency resource instances spaced 36 RBs from the first frequency resource instance. The second set of ROs for LPWA UEs comprises a frequency resource instance offset by 48 RBs from the initial BWP; accordingly, there is an overlap at the RO offset by 48 RBs from the initial BWP which is an RO common to both the first and second sets of ROs.

As shown in FIG. 9, to resolve the overlap the non-LPWA UEs may shift (in frequency) the second RO of first set of ROs due to overlap with the RO of the LPWA UE. Accordingly, the non-LPWA UE may determine an alternative set of frequency resources (e.g., a different FDMed RO) based on a determined overlap between ROs for LPWA UEs and ROs for non-LPWA UEs, such that the alternative set of time resources of the ROs for LPWA UEs differ from the time resources of the ROs for non-LPWA UEs.

As depicted, the second RO may be shifted (in frequency) so that its spacing from the first RO of the first set of ROs is now 24 RBs. Accordingly, there would be a spacing of 48 RBs between the (shifted) second RO and the third RO, but a frequency domain spacing of 36 RBs between the third RO and subsequent ROs.

In some embodiments, the non-LPWA UE determines such a shift based on the starting offset of the RO of the LPWA UE. In other words, the non-LPWA UEs may determine a third set of valid ROs that includes the non-overlapping ROs from the first set of ROs and does not include any ROs from the second set of ROs, and wherein the overlapping RO from the first set of ROs is shifted in frequency to not overlap with the second set of ROs.

FIG. 10 illustrates an example of a third allocation scheme 1000 for ROs of LPWA UEs and non-LPWA UEs, in accordance with aspects of the present disclosure. In some examples, the third allocation scheme 1000 is implemented by aspects of the wireless communications system 100, for example, implemented by a UE and a NE, which may be examples of a UE 104 and a NE 102, e.g., as described with reference to FIG. 1.

In the example of FIG. 10, the network (e.g., NE) may indicate a first set of ROs for non-LPWA UEs, and a second set of ROs for LPWA UEs. The first set of ROs for non-LPWA UEs comprises a first frequency resource instance offset by 12 RBs from the initial BWP, and subsequent frequency resource instances spaced 36 RBs from the first frequency resource instance. The second set of ROs for LPWA UEs comprises a frequency resource instance offset by 48 RBs from the initial BWP; accordingly, there is an overlap at the RO offset by 48 RBs from the initial BWP which is an RO common to both the first and second sets of ROs.

As shown in FIG. 10, to resolve the overlap the non-LPWA UEs may shift (in frequency) the second RO of first set of ROs due to overlap with the RO of the LPWA UE, and may additionally maintain the original spacing of 36 RBs between the second RO and subsequent ROs of the first set of ROs. Accordingly, the non-LPWA UE may determine an alternative set of frequency resources (e.g., a different FDMed RO) based on a determined overlap between ROs for LPWA UEs and ROs for non-LPWA UEs, such that the alternative set of frequency resources of the ROs for non-LPWA UEs differ from the frequency resources of the ROs for LPWA UEs.

As depicted, the second RO may be shifted so that its frequency domain spacing from the first RO of the first set of ROs is now 48 RBs, and the third and fourth (and subsequent) ROs of the first set of ROs are shifted to maintain the 36 RB spacing.

In some embodiments, the non-LPWA UE determines such a shift based on the starting offset of the RO of the LPWA UE. In other words, the non-LPWA UEs may determine a third set of valid ROs that includes the non-overlapping ROs from the first set of ROs and does not include any ROs from the second set of ROs, and wherein the overlapping RO and subsequent ROs from the first set of ROs are shifted in frequency to not overlap with the second set of ROs.

In an alternative embodiment, instead of shifting in the frequency domain, any ROs of the non-LPWA UE that overlap with ROs of the LPWA UEs may be shifted in the time domain to avoid the overlap with the ROs of LPWA UEs. Accordingly, the non-LPWA UE may determine an alternative set of time resources (e.g., next valid slot) based on a determined overlap between ROs for LPWA UEs and ROs for non-LPWA UEs, such that the alternative set of frequency resources of the ROs for non-LPWA UEs differ from the frequency resources of the ROs for LPWA UEs.

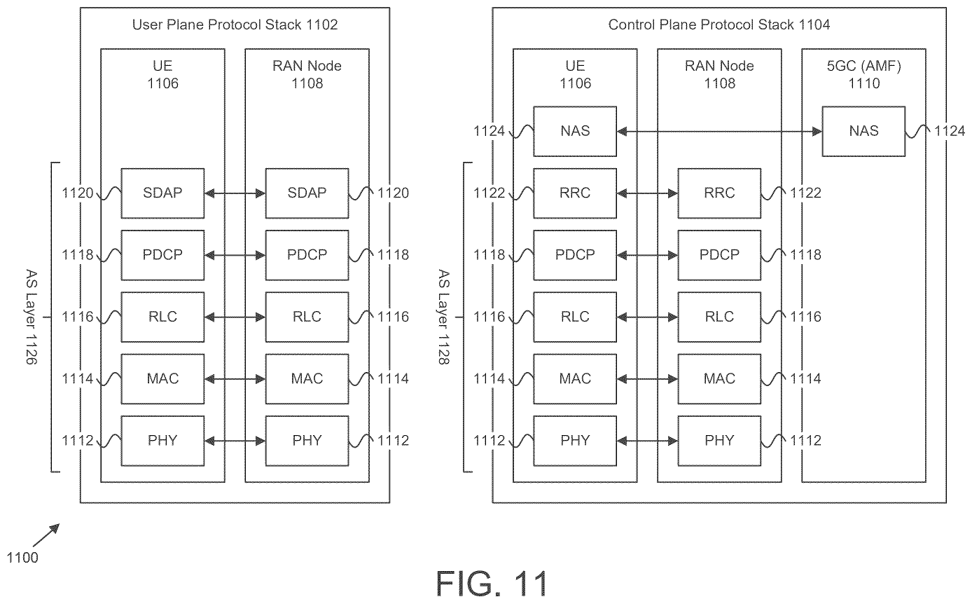

FIG. 11 illustrates an example of a protocol stack 1100, in accordance with aspects of the present disclosure. While FIG. 11 shows a UE 1106, a RAN node 1108, and a 5GC 1110 (e.g., comprising at least an AMF), these are representative of a set of UEs 104 interacting with an NE 102 (e.g., base station) and a CN 106. As depicted, the protocol stack 1100 comprises a User Plane protocol stack 1102 and a Control Plane protocol stack 1104. The User Plane protocol stack 1102 includes a physical (PHY) layer 1112, a MAC sublayer 1114, a Radio Link Control (RLC) sublayer 1116, a Packet Data Convergence Protocol (PDCP) sublayer 1118, and a Service Data Adaptation Protocol (SDAP) layer 1120. The Control Plane protocol stack 1104 includes a PHY layer 1112, a MAC sublayer 1114, a RLC sublayer 1116, and a PDCP sublayer 1118. The Control Plane protocol stack 1104 also includes a Radio Resource Control (RRC) layer 1122 and a Non-Access Stratum (NAS) layer 1124.

The AS layer 1126 (also referred to as “AS protocol stack”) for the User Plane protocol stack 1102 consists of at least SDAP, PDCP, RLC and MAC sublayers, and the physical layer. The AS layer 1128 for the Control Plane protocol stack 1104 consists of at least the RRC sublayer 1122, the PDCP sublayer 1118, the RLC sublayer 1116, the MAC sublayer 1114, and the PHY layer 1112. The Layer-1 (L1) includes the PHY layer 1112. The Layer-2 (L2) is split into the SDAP sublayer 1120, PDCP sublayer 1118, RLC sublayer 1116, and MAC sublayer 1114. The Layer-3 (L3) includes the RRC layer 1122 and the NAS layer 1124 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 1112 offers transport channels to the MAC sublayer 1114. The PHY layer 1112 may perform a beam failure detection procedure using energy detection thresholds, as described herein. In certain implementations, the PHY layer 1112 may send an indication of beam failure to a MAC entity at the MAC sublayer 1114. The MAC sublayer 1114 offers logical channels (LCHs) to the RLC sublayer 1116. The RLC sublayer 1116 offers RLC channels to the PDCP sublayer 1118.

The PDCP sublayer 1118 offers radio bearers to the SDAP sublayer 1120 and/or RRC layer 1122. The SDAP sublayer 1120 offers QoS flows to the core network (e.g., 5GC). The RRC layer 1122 provides for the addition, modification, and release of carrier aggregation (CA) and/or dual connectivity. The RRC layer 1122 also manages the establishment, configuration, maintenance, and release of signaling radio bearers (SRBs) and data radio bearers (DRBs).

The NAS layer 1124 is between the UE 1106 and an AMF in the 5GC 1110. NAS messages are passed transparently through the RAN. The NAS layer 1124 is used to manage the establishment of communication sessions and for maintaining continuous communications with the UE 1106 as it moves between different cells of the RAN. In contrast, the AS layers 1126 and 1128 are between the UE 1106 and the RAN (i.e., RAN node 1108) and carry information over the wireless portion of the network. While not depicted in FIG. 11, the IP layer exists above the NAS layer 1124, a transport layer exists above the IP layer, and an application layer exists above the transport layer.

The MAC sublayer 1114 is the lowest sublayer in the L2 architecture of the NR protocol stack. Its connection to the PHY layer 1112 below is through transport channels, and the connection to the RLC sublayer 1116 above is through LCHs. The MAC sublayer 1114 therefore performs multiplexing and demultiplexing between LCHs and transport channels: the MAC sublayer 1114 in the transmitting side constructs MAC PDUs (also known as Transport Blocks (TBs)) from MAC Service Data Units (SDUs) received through LCHs, and the MAC sublayer 1114 in the receiving side recovers MAC SDUs from MAC PDUs received through transport channels.

The MAC sublayer 1114 provides a data transfer service for the RLC sublayer 1116 through LCHs, which are either control LCHs which carry control data (e.g., RRC signaling) or traffic LCHs which carry user plane data. On the other hand, the data from the MAC sublayer 1114 is exchanged with the PHY layer 1112 through transport channels, which are classified as UL or DL. Data is multiplexed into transport channels depending on how it is transmitted over the air.

The PHY layer 1112 is responsible for the actual transmission of data and control information via the air interface, i.e., the PHY layer 1112 carries all information from the MAC transport channels over the air interface on the transmission side. Some of the important functions performed by the PHY layer 1112 include coding and modulation, link adaptation (e.g., Adaptive Modulation and Coding (AMC)), power control, cell search and random access (for initial synchronization and handover purposes) and other measurements (inside the 3rd Generation Partnership Project (3GPP) system (i.e., NR and/or LTE system) and between systems) for the RRC layer 1122. The PHY layer 1112 performs transmissions based on transmission parameters, such as the modulation scheme, the coding rate (i.e., the modulation and coding scheme (MCS)), the number of physical resource blocks (PRBs), etc.

In some implementations, the protocol stack 1100 may be an NR protocol stack used in a 5G NR system. In other implementations, the protocol stack 1100 may be an LTE protocol stack used in a 4G LTE system Note that an LTE protocol stack comprises similar structure to the protocol stack 1100, with the differences that the LTE protocol stack lacks the SDAP sublayer 1120 in the AS layer 1126, that an EPC replaces the 5GC 510, and that the NAS layer 1124 is between the UE 1106 and an MME in the EPC.

Also note that the present disclosure distinguishes between a protocol layer (e.g., as shown in FIG. 11) and a transmission layer in multiple-input multiple-output (MIMO) communication. Examples of a protocol layer includes the aforementioned PHY layer 1112, MAC sublayer 1114, RLC sublayer 1116, PDCP sublayer 1118, SDAP sublayer 1120, RRC layer 1122 and NAS layer 1124. In certain embodiments, a transmission layer may also referred to as a “MIMO layer” or a “data stream”.

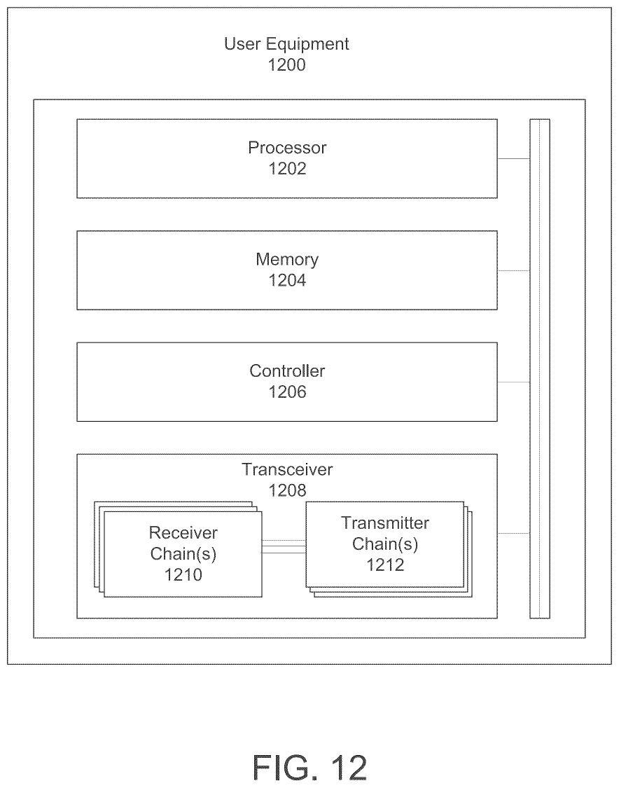

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a central processing unit (CPU), an ASIC, a field programmable gate array (FPGA), or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions that, when executed by the processor 1202, cause the UE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform various functions (e.g., operations, signaling) described herein (e.g., executing, by the processor 1202, instructions stored in the memory 1204). In some implementations, the processor 1202 may include multiple processors and the memory 1204 may include multiple memories. One or more of the multiple processors may be coupled with one or more of the multiple memories, which may be individually or collectively, configured to perform various functions (e.g., operations, signaling) of the UE 1200 as described herein.

The processor 1202 coupled with the memory 1204 may be configured to, capable of, or operable to cause the UE 1200 to receive a first RACH configuration and a second RACH configuration, where the first RACH configuration is associated with a first set of ROs and the second RACH configuration is associated with a second set of ROs; determine a set of valid ROs based on the first set of ROs and the second set of ROs, where the set of valid ROs excludes ROs of the second set of ROs, and where at least one RO of the set of valid ROs is associated with the first set of ROs; and transmit a RACH transmission in a RO of the set of valid ROs.

In some implementations, each RO of one or more of the first set of ROs, the second set of ROs, or the set of valid ROs comprises is defined by a set of time-frequency resources and is associated with a set of RACH preambles. In some implementations, to determine the set of valid ROs, the processor 1202 coupled with the memory 1204 may be configured to, capable of, or operable to cause the UE 1200 to determine an overlap between a respective RO of the first set of ROs and one or more ROs of the second set of ROs, where the overlap is within one or more of a time domain, a frequency domain, or a code domain; and exclude the respective RO from the set of valid ROs based at least in part on an overlap between the respective RO of the first set of ROs and the one or more ROs of the second set of ROs.

In certain implementations, the overlap in the code domain is based at least in part on a set of RACH preambles associated with the respective RO. Note that the ROs are overlapping in the code domain when the set of RACH preambles associated with the RO is not among a set of predetermined RACH preambles. In some implementations, a first RO of the set of valid ROs overlaps in time and in frequency with a second RO of the second set of ROs, where first RO is associated with a different set of RACH preambles than the second RO.

In some implementations, to determine the set of valid ROs, the processor 1202 coupled with the memory 1204 may be configured to, capable of, or operable to cause the UE 1200 to determine an overlap between a first RO of the first set of ROs and a second RO of the second set of ROs, where the overlap is within one or more of a time domain, a frequency domain, or a code domain, and where the first RO and the second RO are associated with a same set of RACH preambles; determine an alternative set of time resources based at least in part on the determined overlap, where the determined alternative set of time resources differ from a second set of time resources associated with the second RO; and include in the set of valid ROs a third RO comprising a same set of frequency resources as the first RO, the same set of RACH preambles, and the determined alternative set of time resources.

In certain implementations, the processor 1202 coupled with the memory 1204 may be configured to, capable of, or operable to cause the UE 1200 to determine the alternative set of time resources according to a mapping between a set of time resources of the first RO to one or more candidate sets of time resources.

In some implementations, to determine the set of valid ROs, the processor 1202 coupled with the memory 1204 may be configured to, capable of, or operable to cause the UE 1200 to determine an overlap between a first RO of the first set of ROs and a second RO of the second set of ROs, where the overlap is within one or more of a time domain, a frequency domain, or a code domain, and where the first RO and the second RO are associated with a same set of RACH preambles; determine an alternative set of frequency resources based at least in part on the determined overlap, where the determined alternative set of frequency resources differ from a second set of frequency resources associated with the second RO; and include in the set of valid ROs a third RO comprising a same set of time resources as the first RO, the same set of RACH preambles, and the determined alternative set of frequency resources.

In certain implementations, the processor 1202 coupled with the memory 1204 may be configured to, capable of, or operable to cause the UE 1200 to determine the alternative set of frequency resources according to a mapping between a set of frequency resources of the first RO to one or more candidate sets of frequency resources.

In certain implementations, the processor 1202 coupled with the memory 1204 may be configured to, capable of, or operable to cause the UE 1200 to receive a FDM parameter, and to determine the alternative set of frequency resources based at least in part on the FDM parameter and according to the mapping.

The processor 1202 coupled with the memory 1204 may be configured to, capable of, or operable to cause the UE 1200 to determine a frequency domain spacings between each frequency multiplexed RO of the set of valid ROs based at least in part on the first RACH configuration or the second RACH configuration, or both.

The processor 1202 coupled with the memory 1204 may be configured to, capable of, or operable to cause the UE 1200 to determine an SSB-to-RO mapping associated with ROs of the set of valid ROs based at least in part on the first RACH configuration or the second RACH configuration, or both.

The controller 1206 may manage input and output signals for the UE 1200. The controller 1206 may also manage peripherals not integrated into the UE 1200. In some implementations, the controller 1206 may utilize an operating system (OS) such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding/processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

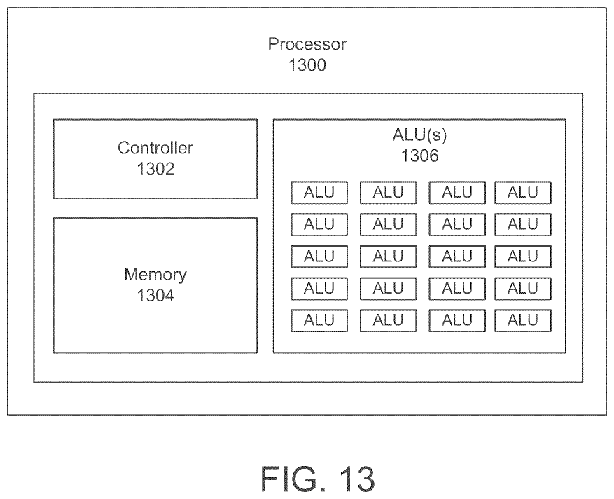

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1, or L2, or L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

In some implementations, the processor 1300 may support various functions (e.g., operations, signaling) of a UE, in accordance with examples as disclosed herein. For example, the controller 1302 coupled with the memory 1304 may be configured to, capable of, or operable to cause the processor 1300 to receive a first RACH configuration and a second RACH configuration, where the first RACH configuration is associated with a first set of ROs and the second RACH configuration is associated with a second set of ROs; determine a set of valid ROs based on the first set of ROs and the second set of ROs, where the set of valid ROs excludes ROs of the second set of ROs, and where at least one RO of the set of valid ROs is associated with the first set of ROs; and transmit a RACH transmission in a RO of the set of valid ROs. Additionally, the controller 1302 coupled with the memory 1304 may be configured to, capable of, or operable to cause the processor 1300 to perform one or more functions (e.g., operations, signaling) of the UE as described herein.

Additionally, or alternatively, in some other implementations, the processor 1300 may support various functions (e.g., operations, signaling) of a NE (e.g., base station), in accordance with examples as disclosed herein. For example, the controller 1302 coupled with the memory 1304 may be configured to, capable of, or operable to cause the processor 1300 to transmit a first RACH configuration and a second RACH configuration, where the first RACH configuration is associated with a first set of ROs and the second RACH configuration is associated with a second set of ROs; determine, for a set of UEs, a set of valid ROs based on the first set of ROs and the second set of ROs, where the set of valid ROs excludes ROs of the second set of ROs, and where at least one RO of the set of valid ROs is associated with the first set of ROs; and receive, from a UE, a RACH transmission in a RO of the set of valid ROs. Additionally, the controller 1302 coupled with the memory 1304 may be configured to, capable of, or operable to cause the processor 1300 to perform one or more functions (e.g., operations, signaling) of the NE as described herein.

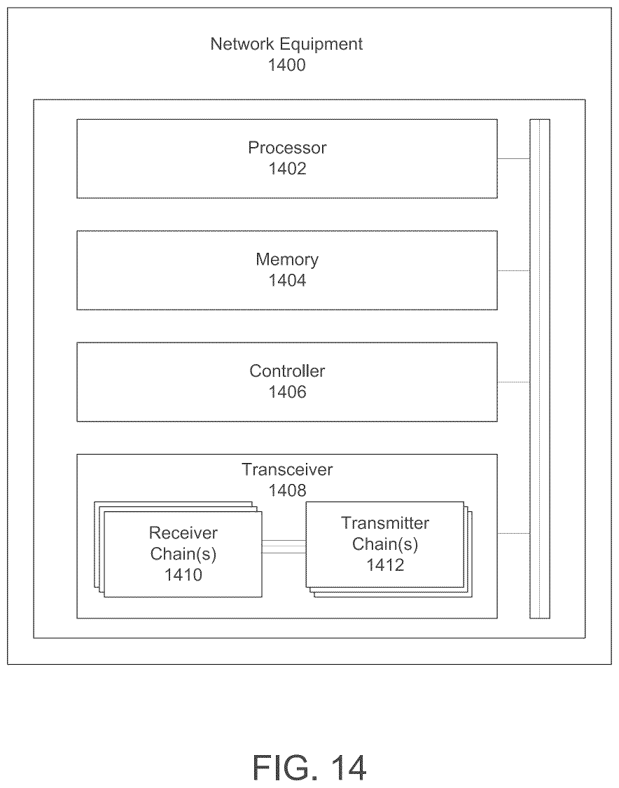

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform various functions (e.g., operations, signaling) described herein (e.g., executing, by the processor 1402, instructions stored in the memory 1404). In some implementations, the processor 1402 may include multiple processors and the memory 1404 may include multiple memories. One or more of the multiple processors may be coupled with one or more of the multiple memories, which may be individually or collectively, configured to perform various functions (e.g., operations, signaling) of the NE 1400 as described herein.

The processor 1402 coupled with the memory 1404 may be configured to, capable of, or operable to cause the NE 1400 to transmit a first RACH configuration and a second RACH configuration, where the first RACH configuration is associated with a first set of ROs and the second RACH configuration is associated with a second set of ROs; determine, for a set of UEs, a set of valid ROs based on the first set of ROs and the second set of ROs, where the set of valid ROs excludes ROs of the second set of ROs, and where at least one RO of the set of valid ROs is associated with the first set of ROs; and receive, from a UE, a RACH transmission in a RO of the set of valid ROs.

In some implementations, each RO of one or more of the first set of ROs, the second set of ROs, or the set of valid ROs is defined by a set of time-frequency resources and a set of RACH preambles. In some implementations, to determine the set of valid ROs, the processor 1402 coupled with the memory 1404 may be configured to, capable of, or operable to cause the NE 1400 to determine an overlap between a respective RO of the first set of ROs and one or more ROs of the second set of ROs, where the overlap is within one or more of a time domain, a frequency domain, or a code domain; and exclude the respective RO from the set of valid ROs based at least in part on the determined overlap between the respective RO of the first set of ROs and the one or more ROs of the second set of ROs.

In some implementations, the overlap in the code domain is based on a set of RACH preambles corresponding to the respective RO. In some implementations, a first RO of the set of valid ROs overlaps in time and in frequency with a second RO of the second set of ROs, where first RO is associated with a different set of RACH preambles than the second RO.

In some implementations, to determine the set of valid ROs, the processor 1402 coupled with the memory 1404 may be configured to, capable of, or operable to cause the NE 1400 to determine an overlap between a first RO of the first set of ROs and a second RO of the second set of ROs, where the overlap is within a time domain or a frequency domain, or both, and where the first RO and the second RO are associated with a same set of RACH preambles; determine an alternative set of time resources based at least in part on the determined overlap, wherein the determined alternative set of time resources differ from a second set of time resources associated with the second RO; and include in the set of valid ROs a third RO comprising a same set of frequency resources as the first RO, the same set of RACH preambles, and the determined alternative set of time resources.

In certain implementations, the processor 1402 coupled with the memory 1404 may be configured to, capable of, or operable to cause the NE 1400 to determine the alternative set of time resources according to a mapping between a set of time resources of the first RO to one or more candidate sets of time resources.

In some implementations, to determine the set of valid ROs, the processor 1402 coupled with the memory 1404 may be configured to, capable of, or operable to cause the NE 1400 to determine an overlap between a first RO of the first set of ROs and a second RO of the second set of ROs, where the overlap is within a time domain or a frequency domain, or both, and where the first RO and the second RO are associated with a same set of RACH preambles; determine an alternative set of frequency resources based at least in part on the determined overlap, wherein the determined alternative set of frequency resources differ from a second set of frequency resources associated with the second RO; and include in the set of valid ROs a third RO comprising a same set of time resources as the first RO, the same set of RACH preambles, and the determined alternative set of frequency resources.

In certain implementations, the processor 1402 coupled with the memory 1404 may be configured to, capable of, or operable to cause the NE 1400 to determine the alternative set of frequency resources according to a mapping between a set of frequency resources of the first RO to one or more candidate sets of frequency resources.

The processor 1402 coupled with the memory 1404 may be configured to, capable of, or operable to cause the NE 1400 to determine a frequency domain spacing between each frequency multiplexed RO of the set of valid ROs based at least in part on the first RACH configuration or the second RACH configuration, or both.

The processor 1402 coupled with the memory 1404 may be configured to, capable of, or operable to cause the NE 1400 to determine an SSB-to-RO mapping associated with ROs of the set of valid ROs based at least in part on the first RACH configuration or the second RACH configuration, or both.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receiving the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the received signal and obtain the transmitted data by reversing the modulation technique applied during transmission of the signal. The receiver chain 1410 may include at least one decoder for decoding/processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

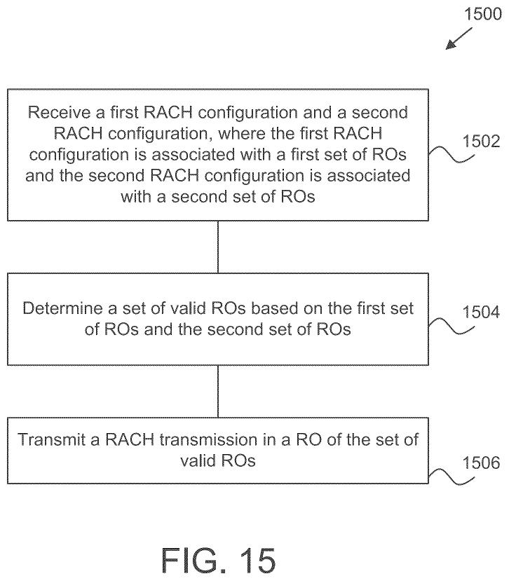

FIG. 15 illustrates a flowchart of a method 1500 in accordance with aspects of the present disclosure. The operations of the method 1500 may be implemented by a UE as described herein. In some implementations, the UE may execute a set of instructions to control the function elements of the UE to perform the described functions.

At step 1502, the method 1500 may include receiving a first RACH configuration and a second RACH configuration. Here, the first RACH configuration is associated with a first set of ROs and the second RACH configuration is associated with a second set of ROs. The operations of step 1502 may be performed in accordance with examples as described herein. In some implementations, aspects of the operations of step 1502 may be performed by a UE, as described with reference to FIG. 12.

At step 1504, the method 1500 may include determining a set of valid ROs based on the first set of ROs and the second set of ROs. Here, the set of valid ROs excludes ROs of the second set of ROs, and at least one RO of the set of valid ROs is associated with the first set of ROs. The operations of step 1504 may be performed in accordance with examples as described herein. In some implementations, aspects of the operations of step 1504 may be performed by a UE, as described with reference to FIG. 12.

At step 1506, the method 1500 may include transmitting a RACH transmission in a RO of the set of valid ROs. The operations of step 1506 may be performed in accordance with examples as described herein. In some implementations, aspects of the operations of step 1506 may be performed by a UE, as described with reference to FIG. 12.

It should be noted that the method 1500 described herein describes one possible implementation, and that the operations and the steps may be rearranged or otherwise modified and that other implementations are possible.

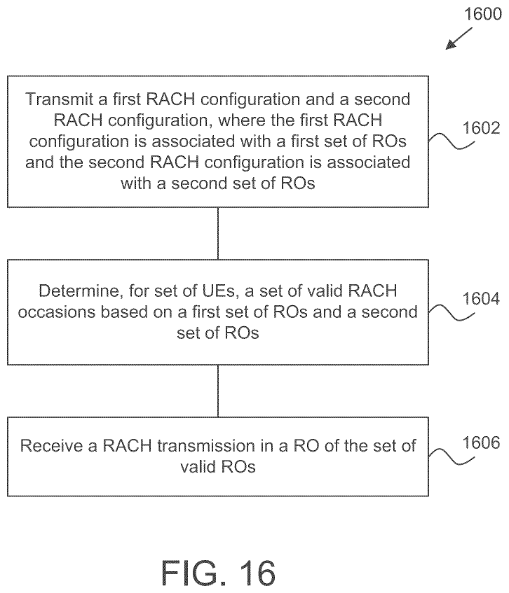

FIG. 16 illustrates a flowchart of a method 1600 in accordance with aspects of the present disclosure. The operations of the method 1600 may be implemented by a NE as described herein. In some implementations, the NE may execute a set of instructions to control the function elements of the NE to perform the described functions.

At step 1602, the method 1600 may include transmitting transmit a first RACH configuration and a second RACH configuration. Here, the first RACH configuration is associated with a first set of ROs and the second RACH configuration is associated with a second set of ROs. The operations of step 1602 may be performed in accordance with examples as described herein. In some implementations, aspects of the operations of step 1602 may be performed by a NE, as described with reference to FIG. 14.

At step 1604, the method 1600 may include determining, for a set of UEs, a set of valid ROs based on the first set of ROs and the second set of ROs. Here, the set of valid ROs excludes ROs of the second set of ROs, and at least one RO of the set of valid ROs is associated with the first set of ROs. The operations of step 1604 may be performed in accordance with examples as described herein. In some implementations, aspects of the operations of step 1604 may be performed by a NE, as described with reference to FIG. 14.

At step 1606, the method 1600 may include receiving, from a UE, a RACH transmission in a RO of the set of valid ROs. The operations of step 1606 may be performed in accordance with examples as described herein. In some implementations, aspects of the operations of step 1606 may be performed by a NE, as described with reference to FIG. 14.

It should be noted that the method 1600 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first random access channel (RACH) configuration and a second RACH configuration, wherein the first RACH configuration is associated with a first set of RACH occasions (ROs) and the second RACH configuration is associated with a second set of ROs;
determine a set of valid ROs based on the first set of ROs and the second set of ROs, wherein the set of valid ROs excludes ROs of the second set of ROs, and wherein at least one RO of the set of valid ROs is associated with the first set of ROs; and
transmit a RACH transmission in a RO of the set of valid ROs.

2. The UE of claim 1, wherein each RO of one or more of the first set of ROs, the second set of ROs, or the set of valid ROs comprises a set of time-frequency resources and is associated with a set of RACH preambles.

3. The UE of claim 1, wherein to determine the set of valid ROs, the at least one processor is configured to cause the UE to:
determine an overlap between a respective RO of the first set of ROs and one or more ROs of the second set of ROs, wherein the overlap is within one or more of a time domain, a frequency domain, or a code domain; and
exclude the respective RO from the set of valid ROs based at least in part on the determined overlap between the respective RO of the first set of ROs and the one or more ROs of the second set of ROs.

4. The UE of claim 3, wherein the overlap in the code domain is based at least in part on a set of RACH preambles associated with the respective RO.

5. The UE of claim 1, wherein to determine the set of valid ROs, the at least one processor is configured to cause the UE to:
determine an overlap between a first RO of the first set of ROs and a second RO of the second set of ROs, wherein the overlap is within a time domain or a frequency domain, or both, and wherein the first RO and the second RO are associated with a same set of RACH preambles;
determine an alternative set of time resources based at least in part on the determined overlap, wherein the determined alternative set of time resources differ from a second set of time resources associated with the second RO; and
include in the set of valid ROs a third RO comprising a same set of frequency resources as the first RO, the same set of RACH preambles, and the determined alternative set of time resources.

6. The UE of claim 5, wherein the at least one processor is configured to cause the UE to determine the alternative set of time resources according to a mapping between a set of time resources of the first RO to one or more candidate sets of time resources.

7. The UE of claim 1, wherein to determine the set of valid ROs, the at least one processor is configured to cause the UE to:
determine an overlap between a first RO of the first set of ROs and a second RO of the second set of ROs, wherein the overlap is within a time domain or a frequency domain, or both, and wherein the first RO and the second RO are associated with a same set of RACH preambles;
determine an alternative set of frequency resources in a frequency domain that differ from a second set of frequency resources associated with the second RO; and
include in the set of valid ROs a third RO comprising a same set of time resources as the first RO, the same set of RACH preambles, and the determined alternative set of frequency resources.

8. The UE of claim 7, wherein the at least one processor is configured to cause the UE to determine the alternative set of frequency resources according to a mapping between a set of frequency resources of the first RO to one or more candidate sets of frequency resources.

9. The UE of claim 8, wherein the at least one processor is further configured to cause the UE to receive a frequency domain multiplexing (FDM) parameter, and wherein the at least one processor is configured to determine the alternative set of frequency resources based at least in part on the FDM parameter and according to the mapping.

10. The UE of claim 1, wherein the at least one processor is further configured to cause the UE to determine a frequency domain spacing between each frequency multiplexed RO of the set of valid ROs based at least in part on the first RACH configuration or the second RACH configuration, or both.

11. The UE of claim 1, wherein the at least one processor is further configured to cause the UE to determine a synchronization signal block (SBB)-to-RO (SSB-to-RO) mapping associated with ROs of the set of valid ROs based at least in part on the first RACH configuration or the second RACH configuration, or both.

12. A method performed by a user equipment (UE), the method comprising:
receiving a first random access channel (RACH) configuration and a second RACH configuration, wherein the first RACH configuration is associated with a first set of RACH occasions (ROs) and the second RACH configuration is associated with a second set of ROs;
determining a set of valid ROs based on the first set of ROs and the second set of ROs,
wherein the set of valid ROs excludes ROs of the second set of ROs, and wherein at least one RO of the set of valid ROs is associated with the first set of ROs; and
transmitting a RACH transmission in a RO of the set of valid ROs.

13. A base station for wireless communication, comprising:
at least one memory; and
at least one processor coupled with the at least one memory and configured to cause the base station to:
transmit a first random access channel (RACH) configuration and a second RACH configuration, wherein the first RACH configuration is associated with a first set of RACH occasions (ROs) and the second RACH configuration is associated with a second set of ROs;
determine, for a set of user equipments (UEs), a set of valid ROs based on the first set of ROs and the second set of ROs,
wherein the set of valid ROs excludes ROs of the second set of ROs, and wherein at least one RO of the set of valid ROs is associated with the first set of ROs; and
receive, from a UE, a RACH transmission in a RO of the set of valid ROs.

14. The base station of claim 13, wherein to determine the set of valid ROs, the at least one processor is configured to cause the base station to:
determine an overlap between a respective RO of the first set of ROs and one or more ROs of the second set of ROs, wherein the overlap is within one or more of a time domain, a frequency domain, or a code domain; and
exclude the respective RO from the set of valid ROs based at least in part on the determined overlap between the respective RO of the first set of ROs and the one or more ROs of the second set of ROs.

15. The base station of claim 14, wherein the overlap in the code domain is based at least in part on a set of RACH preambles associated with the respective RO.

16. The base station of claim 13, wherein to determine the set of valid ROs, the at least one processor is configured to cause the base station to:
determine an overlap between a first RO of the first set of ROs and a second RO of the second set of ROs, wherein the overlap is within a time domain or a frequency domain, or both, and wherein the first RO and the second RO are associated with a same set of RACH preambles;
determine an alternative set of time resources based at least in part on the determined overlap, wherein the determined alternative set of time resources differ from a second set of time resources associated with the second RO; and
include in the set of valid ROs a third RO comprising a same set of frequency resources as the first RO, the same set of RACH preambles, and the determined alternative set of time resources.

17. The base station of claim 13, wherein to determine the set of valid ROs, the at least one processor is configured to cause the base station to:
determine an overlap between a first RO of the first set of ROs and a second RO of the second set of ROs, wherein the overlap is within a time domain or a frequency domain, or both, and wherein the first RO and the second RO are associated with a same set of RACH preambles;
determine an alternative set of frequency resources based at least in part on the determined overlap, wherein the determined alternative set of frequency resources differ from a second set of frequency resources associated with the second RO; and
include in the set of valid ROs a third RO comprising a same set of time resources as the first RO, the same set of RACH preambles, and the determined alternative set of frequency resources.

18. The base station of claim 13, wherein the at least one processor is configured to cause the base station to determine a frequency domain spacing between each frequency multiplexed RO of the set of valid ROs based at least in part on the first RACH configuration or the second RACH configuration, or both.

19. The base station of claim 13, wherein the at least one processor is configured to cause the base station to determine a synchronization signal block (SBB)-to-RO (SSB-to-RO) mapping associated with ROs of the set of valid ROs based at least in part on the first RACH configuration or the second RACH configuration, or both.

20. A method performed by a base station, the method comprising:
transmitting a first random access channel (RACH) configuration and a second RACH configuration, wherein the first RACH configuration is associated with a first set of RACH occasions (ROs) and the second RACH configuration is associated with a second set of ROs;
determining, for a set of user equipments (UEs), a set of valid ROs based on the first set of ROs and the second set of ROs,
wherein the set of valid ROs excludes ROs of the second set of ROs, and wherein at least one RO of the set of valid ROs is associated with the first set of ROs; and
receiving, from a UE, a RACH transmission in a RO of the set of valid ROs.
